(19) United States
(12) Patent Application Publication
(10) Pub. No.: US 2017/0191402 A1
(43) Pub. Date: Jul. 6, 2017

(54) ENGINE COOLING DUAL FAN SYSTEM WITH EC AND DC MOTORS AND METHOD OF OPERATING

(71) Applicant: Robert Bosch GmbH, Stuttgart (DE)

(72) Inventors: Michael Sortor, Lexington, MA (US); Dana Nicgorski, Burlington, MA (US); Stephen Zukowski, Howell, MI (US)

(73) Assignee: Robert Bosch GmbH, Stuttgart (DE)

(21) Appl. No.: 15/320,417

(22) PCT Filed: Jun. 19, 2015
(86) PCT No.: PCT/US15/36748

§ 371 Date: Dec. 20, 2016

Related U.S. Application Data
(60) Provisional application No. 62/017,532, filed on Jun. 26, 2014.

(51) Int. Cl. F01P 5/04; F01P 9/06; B60H 1/32; F01P 7/04

(52) U.S. Cl. CPC F01P 5/04; F01P 7/048; F01P 9/06; B60H 1/3204; B60H 1/3227; F01P 2005/046; B60H 2001/3251; B60H 2001/326; B60H 2001/3277

(57) ABSTRACT

Method of cooling a heat exchanger of an engine using a cooling fan system includes: measuring conditions of an engine cooling system, determining a desired fan cooling demand. Based on the fan cooling demand, a fan control circuit operates to selectively control an electrically commutated (EC) motor at a continuously variable speed for an EC cooling fan and to control a direct current (DC) motor of a DC cooling fan. The DC motor is controlled to: not operate the DC cooling fan, operate the DC motor at a first predetermined operating speed, and operate the DC motor at a second predetermined operating speed corresponding to a second DC motor speed signal that is less than the first predetermined operating speed. The conditions for determining fan cooling demand include at least one of a temperature and a pressure of an engine coolant and of a refrigerant of a vehicle air conditioning system.

### RELATED APPLICATIONS

This application claims priority from U.S. provisional application 62/017,532, filed Jun. 26, 2014, the entire content of which is hereby incorporated by reference.

### BACKGROUND

The present invention relates to an engine cooling dual fan system for a motor vehicle that includes a first cooling fan having a direct current (DC) motor and a second variably controlled cooling fan having an electrically commutated (EC) motor. The fans are used to cool a heat exchanger, such as a radiator.

In vehicle cooling systems, typically fans and motors are sized so as to satisfy the vehicle's cooling demand at the most severe use condition (e.g. hot weather, hill climbing, trailer towing, etc.). In most driving conditions the vehicle does not require the full capacity of the cooling fans and motors for cooling, so it is advantageous to provide some means for reducing the operating power level of the cooling fans when the full capacity is not needed. Operating at lower power reduces the energy consumption of the electric motors, reduces annoyance due to the fan noise, extends the life of the electric motors, and potentially reduces the energy consumption of the vehicle. The greatest benefits of reduced fan power are achieved when the fan speeds can be continuously varied, so as to match the fan power to the fan cooling demand of the vehicle at all times.

Engine cooling fan (ECF) modules with dual fans and motors are commonly used on motor vehicles. Typical speed control methods with DC motors include: two single speed DC motors that can be independently turned on or off, two DC motors that can be connected in series to operate fans at a low speed, and one or both DC motors that can be operated with a series resistor for low speed. These approaches result in fixed speed levels. In another arrangement, one or both of the DC motors can be operated with a pulse width modulated (PWM) speed controller to achieve variable speed control.

Engine cooling fan modules with a pair of brushless motors (also known as electrically commutated (EC) motors) are known for providing controlled cooling. This arrangement provides variable speed control for both of the cooling fans, resulting in higher efficiency and longer operating life compared with DC motors. However, EC motors are significantly more expensive than DC motors.

In a known product (BOSCH), a DC motor and an EC motor are provided with a cooling fan module for powering dual fans. The DC motor and the EC motor each receive a PWM drive signal to continuously vary the speeds of the respective fans.

DE 10 2008 041 236 A1 (hereinafter DE '236) discloses a multiple fan arrangement having a first EC motor and a second DC motor. In DE '236, the EC motor is variably controllable from no rotation to maximum speed and the DC motor is simply an on/off motor that operates at only full speed. Thus, in operation, there are instances wherein the fan module is not operated efficiently, as discussed below.

One goal of the present invention is to design an engine cooling dual fan system which offers all or most of the benefits of EC motors, but at a lower cost compared with a cooling fan system having dual EC motors.

### SUMMARY

The present invention describes a configuration of an engine cooling fan system with one EC motor and one DC motor that provides an essentially continuously variable range of airflow through the cooling system and thereby provides most of the benefits of a dual EC motor system, while using significantly less expensive components.

In one embodiment, a cooling fan system for a vehicle comprises an EC cooling fan including an electrically commutated (EC) motor with a continuously variable speed over a defined range, a DC cooling fan including a direct current (DC) motor having a first predetermined operating speed and a second predetermined operating speed that is less than the first predetermined operating speed; and a fan control circuit for controlling the variable speed of the EC motor in response to an EC motor speed signal, and for controlling the DC motor in response to a first DC motor speed signal and a second DC motor speed signal.

In one embodiment the cooling fan system comprises an engine cooling dual fan system. In another embodiment, the fan control circuit includes a resistor in series with the DC motor for operating the DC motor at a second predetermined operating speed.

In one embodiment, the fan control circuit includes a DC motor with multiple armature windings, a disconnecting circuit for disconnecting one or more brushes of the DC motor, or a connecting circuit for connecting additional brushes for operating the DC motor at the first predetermined operating speed and at the second predetermined operating speed.

In one embodiment, one of the DC motor speed signals is directly provided by a temperature switch integrated into one of an engine cooling system and a vehicle air conditioning system. In another embodiment, the first DC motor speed signal is directly provided by a temperature switch integrated into one of an engine cooling system and a vehicle air conditioning system, and the second DC motor speed signal is directly provided by a pressure switch integrated into a vehicle air conditioning system.

One embodiment includes an engine control unit to output the EC motor speed signal and the first and second DC motor speed signals. In another embodiment, the engine control unit includes an EC output port connected to the electronic fan control circuit to provide the EC motor speed signal, wherein the engine control unit includes a separate first DC output port and a second DC output port connected to the electronic fan control circuit to provide the first DC motor speed signal and the second DC motor speed signal, and when no first DC motor speed signal and no second DC motor speed signal is provided by the engine control unit, the DC motor is in an off condition.

In one embodiment, the EC cooling fan and the DC cooling fan operate in one of a first state wherein the EC cooling fan is operating at an essentially continuously variable speed and the DC cooling fan is not operating, a second state wherein the EC cooling fan is operating at an essentially continuously variable speed and the DC cooling fan is operating at the second predetermined operating speed, and a third state wherein the EC cooling fan is operating at an essentially continuously variable speed and the DC cooling fan is operating at the first predetermined operating speed.

In one embodiment, the cooling fan system includes an engine coolant temperature sensor for providing an engine coolant temperature, an engine control unit having a processor configured to: receive the engine coolant temperature, determine a desired change in cooling for engine coolant to obtain an adjustment for a fan cooling demand to obtain a desired coolant temperature, and generate the EC motor speed signal and one from the group consisting of the first DC motor speed signal, the second DC motor speed signal, and no DC motor speed signal depending on the adjustment for the fan cooling demand. The fan control circuit further comprises a first relay configured to receive the first DC motor speed signal, a second relay configured to receive the second DC motor speed signal, and a resistor in series with the DC motor. In the embodiment, the first relay provides power to the DC motor to operate the DC cooling fan via the DC motor at the first predetermined operating speed in response to the first DC motor speed signal, and the second relay provides power to the DC motor via the resistor to operate the DC cooling fan via the DC motor at the second predetermined operating speed in response to the second DC motor speed signal.

In another embodiment, the invention provides a method of cooling a heat exchanger of a vehicle using a cooling fan system comprising: measuring conditions of the cooling system; determining a desired change in cooling for the heat exchanger; based on the desired change in cooling, controlling a fan cooling demand by controlling an electrically commutated (EC) motor for continuously variable speed of an EC cooling fan; and selectively controlling a direct current (DC) motor of a DC cooling fan to perform one of: provide no power to operate the DC cooling fan, operate the DC cooling fan at a first predetermined operating speed corresponding to a first DC motor speed signal and operate the DC cooling fan at a second predetermined operating speed corresponding to a second DC motor speed signal that is less than the first predetermined operating speed.

One embodiment includes measuring conditions of the cooling system including: measuring a temperature of at least one from a group consisting of an engine coolant, engine oil, transmission oil, and a refrigerant of a vehicle air conditioning system; and measuring a pressure of a refrigerant of a vehicle air conditioning system.

In one embodiment, controlling the fan cooling demand includes: at a first breakpoint after start-up of the cooling fan system, essentially simultaneously changing the DC motor from receiving no signal and not operating the DC cooling fan to providing the DC motor with the second DC motor speed signal to operate the DC cooling fan at the second predetermined operating speed, and decreasing the variable speed of the EC cooling fan to essentially offset the increase in speed of the DC cooling fan.

In another embodiment, controlling the combined fan cooling demand includes: at another breakpoint wherein the fan cooling demand of the EC cooling fan and the DC cooling fan is increasing after increasing beyond the first breakpoint after start-up of the cooling fan system, essentially simultaneously changing the DC motor from providing the DC motor with the second DC motor speed signal to operate the DC cooling fan at the second predetermined operating speed to providing the DC motor with the first DC motor speed signal to operate the DC cooling fan at the first predetermined operating speed, and decreasing the variable speed of the EC cooling fan to essentially offset the increase to the first predetermined operating speed of the DC cooling fan.

In one embodiment, the heat exchanger includes a radiator for receiving an engine coolant, and in another embodiment, the heat exchanger includes a condenser for receiving a refrigerant from a vehicle air conditioning system.

Other aspects of the invention will become apparent by consideration of the detailed description and accompanying drawings.

### BRIEF DESCRIPTION OF THE DRAWINGS

FIG. 1 shows a top view of an engine cooling fan system having a pair of cooling fans with both fans operating.

FIG. 2 shows a top view of an engine cooling fan system having a pair of cooling fans with one cooling fan operating.

FIG. 3 illustrates an electrical schematic circuit of the engine cooling fan system that includes an EC motor and a DC motor.

FIG. 4 illustrates an electrical schematic circuit of the engine cooling fan system that includes a pressure switch and a temperature switch for controlling a DC motor.

FIG. 5 is a flowchart for operation of the engine cooling fan system.

FIG. 6 illustrates a graph of an operating speed profile for the DC motor and the EC motor of the engine cooling fan system.

FIG. 7 illustrates electric power versus fan cooling demand for the operating speed profile of FIG. 6 and for prior art arrangements.

FIG. 8 illustrates fan noise versus demand signal for the operating speed profile of FIG. 6 and for prior art arrangements.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

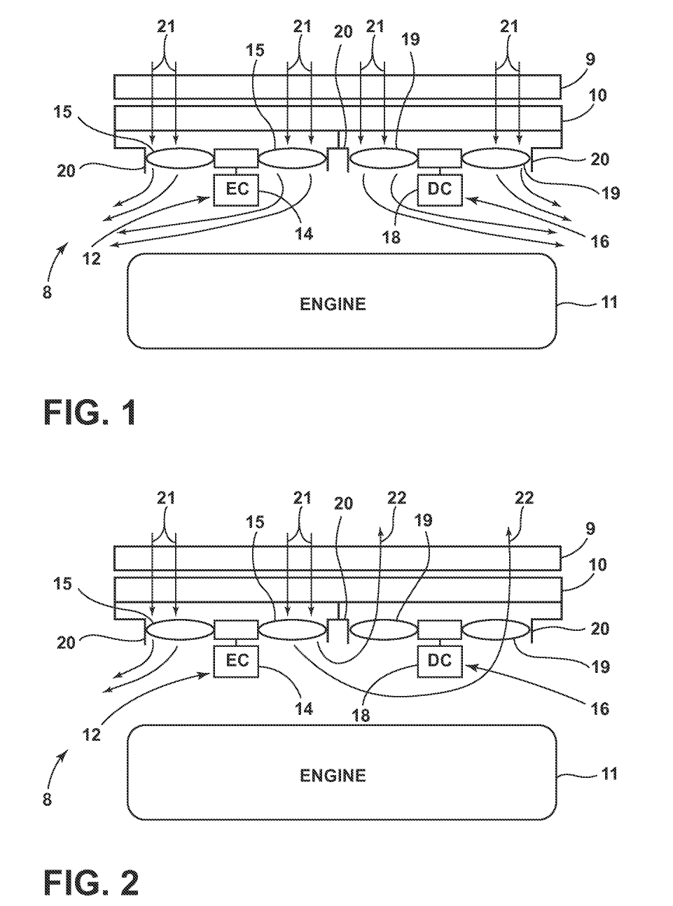

FIG. 1 shows a diagram of an engine cooling fan system 8 that includes a condenser 9 for an air conditioning (AC) system and a radiator 10 of a vehicle power train for carrying engine coolant that is carried to and from a vehicle engine 11. Other heat exchangers are contemplated. Further, FIG. 1 shows a first interior cooling fan having an electrically commutated (EC) motor 14 and fan blades 15. Hereinafter, the first cooling fan is considered an EC cooling fan 12.

Further, in FIG. 1 an interior second cooling fan includes a direct current (DC) motor 18 and fan blades 19. Hereinafter, the interior second cooling fan is considered a DC cooling fan 16. An engine cooling fan module is defined by a shroud 20 enclosing and supporting the two cooling fans 12, 16 having individual motors. The EC cooling fan 12 and the DC cooling fan 16 are mounted in individual shrouds within the housing or in a single shared shroud 20. FIG. 1 also shows a path of air flow 21 through the elements to the engine 11. In FIG. 1, air flow 21 is driven at variable flow rates by the EC cooling fan 12 and the DC cooling fan 16 through the condenser 9 for air conditioning (A/C) refrigerant for the air conditioning system of the vehicle heating, ventilation and air conditioning (HVAC) system and through the radiator 10 for cooling the engine coolant.

FIG. 2 is the top view shown in FIG. 1, except the EC cooling fan 12 is operating while the DC cooling fan 16 is not operating. Further, in FIG. 2, a vehicle including the engine cooling fan system 8 is not moving, for example an engine of the vehicle is idling at a stop light. As the vehicle with the engine cooling fan system 8 is not moving and the DC motor 18 is not operating, some of the air entering an engine compartment via the EC cooling fan 12 that is heated along a path of air flow 21 is returned along a path of air flow 22 to the radiator 10 and the condenser 9. The return of heated air flow 22 in a backward direction is detrimental to cooling of the condenser 9 and the radiator 10.

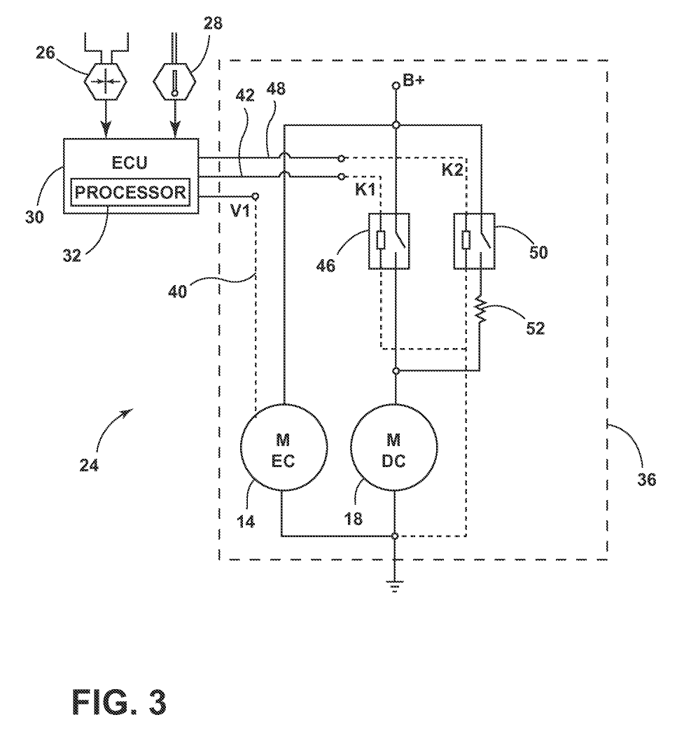

FIG. 3 shows a schematic electrical circuit 24 of an engine cooling fan system 8. The schematic electrical circuit 24 includes a pressure sensor 26, such as an A/C refrigerant pressure sensor for an air conditioning system. The schematic electrical circuit 24 also includes a temperature sensor 28, such as an engine coolant temperature sensor or an A/C refrigerant temperature sensor for an air conditioning system. The temperature sensor 28 also may include one or more of an engine oil temperature and a transmission oil temperature sensor. An additional sensor may provide signals to an engine control unit (ECU) 30 for a vehicle speed. A charging state sensor is contemplated for providing a battery charging state for a plug-in hybrid electric vehicle (PHEV) or an electric vehicle (EV) to the ECU 30.

FIG. 3 also shows the ECU 30 with a plurality of inputs and outputs. In some embodiments, the ECU 30 includes a processor 32 that has an executable program stored in a memory module, such as a read only memory (ROM). The ECU 30 also includes a memory, such as a random access memory (RAM), for storing information that is received from the pressure sensor 26 and temperature sensor 28 via a communication bus or other communication mediums. The ECU 30 may include non-transitory computer readable memory modules, such as volatile memory, non-volatile memory, or a combination thereof and, in various constructions, may also store operating system software, applications/instructions data, and combinations thereof. While discussed herein in the context of an engine cooling fan system 8, the ECU 30 also controls the engine 11 of a vehicle.

The ECU 30 has input ports for receiving signals from the pressure sensor 26 and the temperature sensor 28. Further input ports can receive signals from multiple pressure sensors 26, multiple temperature sensors 28, a vehicle speed sensor (not shown) and a battery charging state sensor. The ECU 30 has a first DC output port to provide a first DC motor speed signal for operating the DC motor 18 at a first predetermined operating speed. The ECU 30 has a separate second DC output port to provide a second DC motor speed signal for operating the DC motor 18 at a second predetermined operating speed that is less than a first predetermined operating speed. The ECU 30 also includes an EC output port for providing an EC speed signal to the EC motor 14.

The schematic electrical circuit 24 of FIG. 3 also shows a fan control circuit 36 that includes an electrically commutated (EC) motor 14 of the EC cooling fan 12. The EC motor 14 is an electrically commutated type with essentially continuously variable speed over a defined range. The direct current (DC) motor 18 of the DC cooling fan 16 typically is a DC brush type motor.

FIG. 3 shows an EC communication line 40 for providing an EC motor speed signal V1 from the ECU 30 to the EC motor 14. FIG. 3 shows another high speed DC communication line 42 for providing a first DC motor speed signal K1 to a first relay 46. The first DC motor speed signal K1 closes the first relay 46 to provide maximum voltage or power to the DC motor 18 of the DC cooling fan 16. The maximum voltage or power translates to the DC cooling fan 16 operating at a first predetermined maximum operating speed.

Further, FIG. 3 shows a low speed DC communication line 48 for providing a second DC motor speed signal K2 to a relay 50. The second DC motor speed signal K2 closes the second relay 50 to provide voltage or power to the DC motor 18 via a resistor 52 in series with the DC motor 18, which reduces the input voltage to DC motor 18. Thus, the second DC motor speed signal K2 results in a second predetermined operating speed of the DC cooling fan 16 that is less than the first predetermined operating speed. Additional relays and resistors may be provided to provide additional operating speeds for the DC cooling fan 16.

The EC motor speed signal V1 and the DC motor speed signals K1, K2 from the ECU 30 are collectively called a demand signal or fan speed demand. The signals V1, K1, K2 result from a fan cooling demand for the engine cooling fan system 8.

Other arrangements may be used to achieve operation of the DC motor 18 with multiple fixed speeds. Such arrangements include, but not limited to: providing multiple armature windings, a disconnecting circuit for disconnecting one or more brushes from the DC motor 18, and a connecting circuit for connecting additional brushes for operating the DC motor 18.

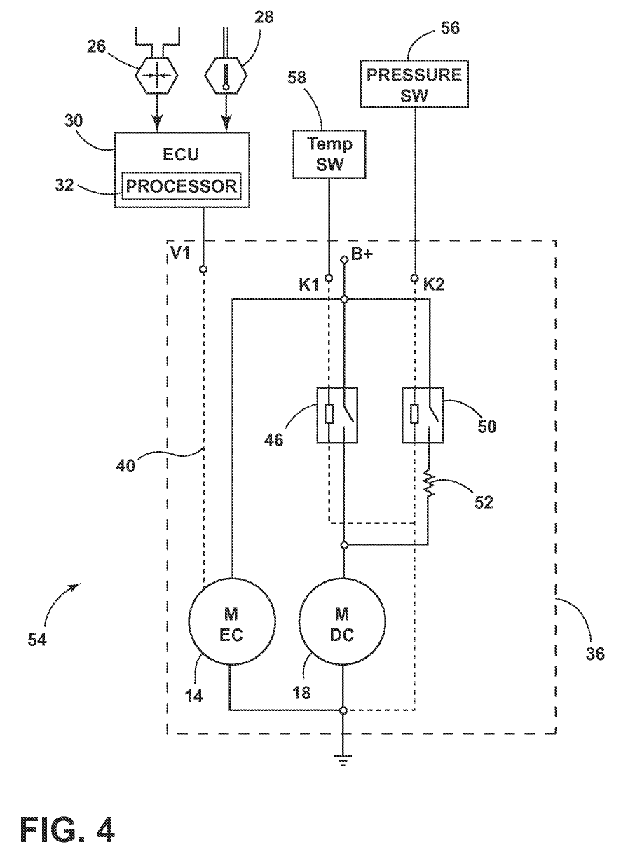

FIG. 4 shows a schematic electrical circuit 54 of another embodiment of an engine cooling fan system 8. Like elements to the schematic electrical circuit 24 shown in FIG. 3 have the same reference numerals and thus discussion thereof is not necessary. The schematic electrical circuit 54 includes a pressure switch 56, such as an A/C refrigerant pressure switch, and a temperature switch 58, such as an A/C refrigerant temperature switch.

In one embodiment, the temperature switch 58 is integrated into one of an engine cooling system and a vehicle air conditioning system to directly provide a DC motor speed signal K1 in the schematic electrical circuit 54 of FIG. 4, while the pressure switch 56 is integrated into one of an engine cooling system and a vehicle air conditioning system to directly provide a second DC motor speed signal K2.

In another embodiment, the temperature switch 58 of the schematic electrical circuit 54 is an engine coolant temperature switch for sensing a predetermined engine coolant temperature. The temperature switch 58 is integrated into one of an engine cooling system and a vehicle air conditioning system and directly provides one of the DC motor speed signals.

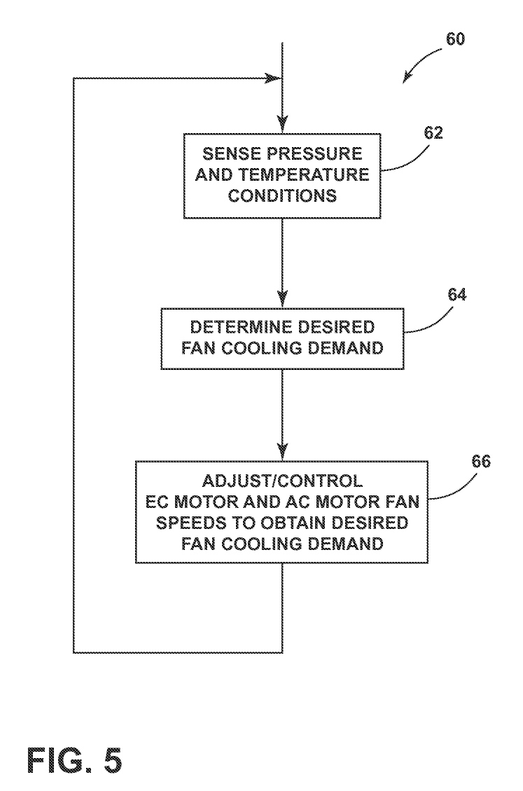

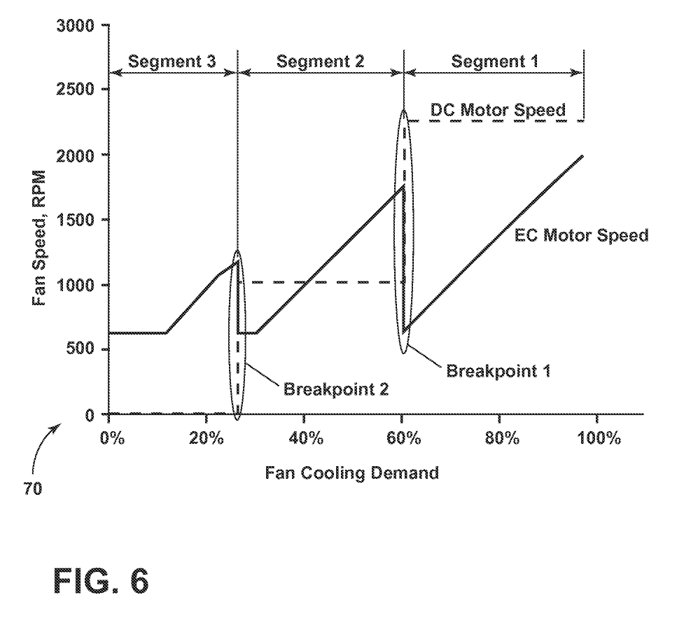

FIG. 5 is a flowchart 60 showing a program or algorithm for the operation of the engine cooling fan system 8. FIG. 6 shows a graph 70 for an embodiment of an operating fan speed profile for fan speed from the EC motor 14 and for the DC motor 18. The method of controlling the EC motor 14 and the DC motor 18 is established by defining a target profile of airflow or electric power as a function of the fan cooling demand and then determining the operating states (speed settings) of the two cooling fans 12, 16 to approximately achieve the target profile. The resulting map of fan operating states is the “operating profile” of the cooling fans 12, 16 as shown in FIG. 6. The operating profile may be determined in conjunction with an expected or actual vehicle cooling demand profile (e.g. for a typical driving cycle) so as to minimize the total energy consumed over all driving conditions.

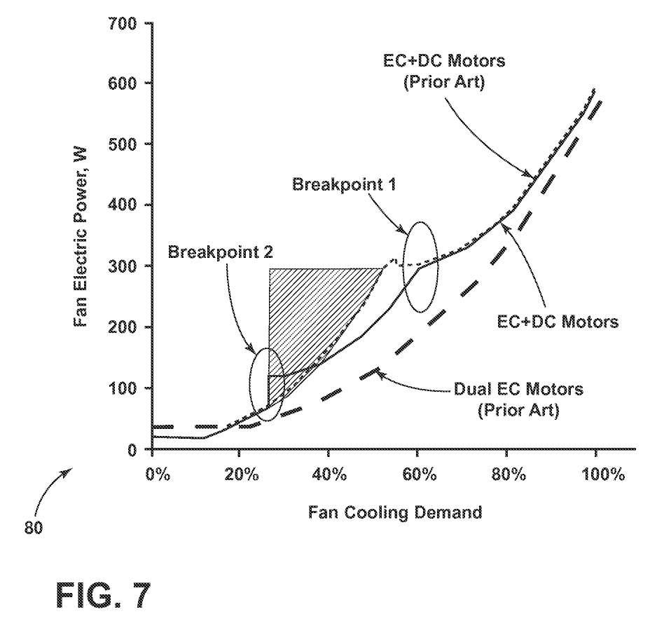

FIG. 7 shows a graph 80 for electric power of the two cooling fans 12, 16 as a function of fan cooling demand corresponding to a target profile as in FIG. 6.

Operation

In the flowchart 60 shown in FIG. 5, at a first step 62, vehicle operating conditions (pressures, temperatures, vehicle speed, and battery charge state) are sensed and provided to a processor 32 of the ECU 30. The program advances to step 64.

At step 64, the processor 32 of the ECU 30 is configured to determine a fan cooling demand for the combination of the EC motor 14 and DC motor 18 that correspond, in one embodiment, to a percentage of the maximum cooling output possible when operating each of the EC motor 14 and the DC motor 18 at maximum power. The processor 32 advances to step 66.

At step 66, the ECU 30 adjusts an EC motor speed signal V1 and provides a DC motor speed signal K1, K2 or no motor speed signal to the fan control circuit 36. In response to the EC motor speed signal V1, the EC motor 14 is driven. In response to the DC motor speed signal K1, K2 or no motor speed signal, the fan control circuit 36 selectively drives the DC motor 18. The fan cooling demand results in appropriate individual fan speeds for the EC motor 14 of the EC cooling fan 12 and the DC motor 18 of the DC cooling fan 16.

As shown in the graph 70 of FIG. 6, for a segment 3 or a third state 3, the DC motor is in an off condition and when fan cooling demand occurs, the EC motor 14 operates at a minimum fan speed of about 600 rpm. At breakpoint 2, the ECU 30 provides a second DC motor speed signal K2 so the DC motor 18 operates at a second predetermined operating speed, and the EC motor speed signal V1 of the EC motor 14 is reduced to decrease the fan speed of the EC cooling fan 12. FIG. 7 shows that electric power provided to the pair of the EC motor 14 and the DC motor 18 at breakpoint 2 is increased to about 120 watts. The processor 32 then returns to step 62.

Thereafter, the program repeats steps 62, 64, 66 to provide the proper cooling output from the EC cooling fan 12 and the DC cooling fan 16 to correspond to the fan cooling demand. When further fan cooling demand is determined at step 64, the fan speeds of the cooling fans 12 and 16 are increased at step 66 as follows. As shown in FIG. 6, in segment 2 or a second state 2, the ECU 30 maintains the second DC motor speed signal K2 to operate the DC motor 18 at the essentially constant second predetermined operating speed shown in broken line in FIG. 6, while the EC motor speed signal V1 is increased so that the essentially continuously variable speed of the EC motor 14 shown in solid line in FIG. 6 is increased.

As the program repeats steps 62, 64, 66 when further fan cooling demand is required, the program reaches breakpoint 1 as shown in FIG. 6 and FIG. 7. At breakpoint 1, the ECU 30 outputs a first DC motor speed signal K1 and the DC motor 18 transitions to a first predetermined maximum operating speed. The ECU 30 essentially simultaneously outputs an EC motor speed signal V1 to the EC motor 14 that reduces power to and lowers the operating speed or discontinues operation of the EC motor 14. Thus, the decrease in power to the EC motor 14 provides a decrease in operating speed of the EC motor 14 that essentially offsets an increase in speed of the DC motor 18. FIG. 7 shows an overall increase in fan electric power for the EC motor 14 and the DC motor 18 at breakpoint 1 and advancement thereafter into segment 1 or a first state 1. Thereafter, an increase in fan cooling demand increases the EC motor speed signal V1 to operate the EC motor 14 at a maximum fan speed.

In conclusion, in one embodiment at step 64, the processor 32 is configured to determine a desired change in cooling for engine coolant to obtain an adjustment for a fan cooling demand to obtain a desired coolant temperature. At step 66, the processor 32 generates the EC motor speed signal V1 and one from the group consisting of the first DC motor speed signal K1, the second DC motor speed signal K2, and no DC motor speed signal depending on the adjustment for the fan cooling demand.

Thereafter, when additional cooling is required by the ECU 30 at step 64, the operating speed of the EC motor 14 is increased within segment 1 until a maximum fan cooling demand of 100% or other target value to provide necessary cooling is obtained.

The schematic electrical circuit 54 shown in FIG. 4 operates in a similar manner to the arrangement discussed above with respect to FIG. 5 except as follows. As in the FIG. 3 embodiment, the operating speed of the EC motor 14 is controlled by the ECU 30 based on at least one of inputs from a pressure sensor 26 and a temperature sensor 28. Operation of the FIG. 4 embodiment is simplified, however, by having a pressure switch 56 act to close relay 50 and provide the second predetermined operating speed to the DC motor 18. Thus, the pressure switch 56 triggers the second breakpoint. Further, a temperature switch 58 operates to close relay 46 and provide a maximum voltage to the DC motor 18 causing a maximum first predetermined operating speed for the DC motor. Thus, in the FIG. 4 arrangement, the ECU 30 does not determine and provide signals K1, K2 to the relays of the DC motor 18.

Comparison with Prior Art Arrangements

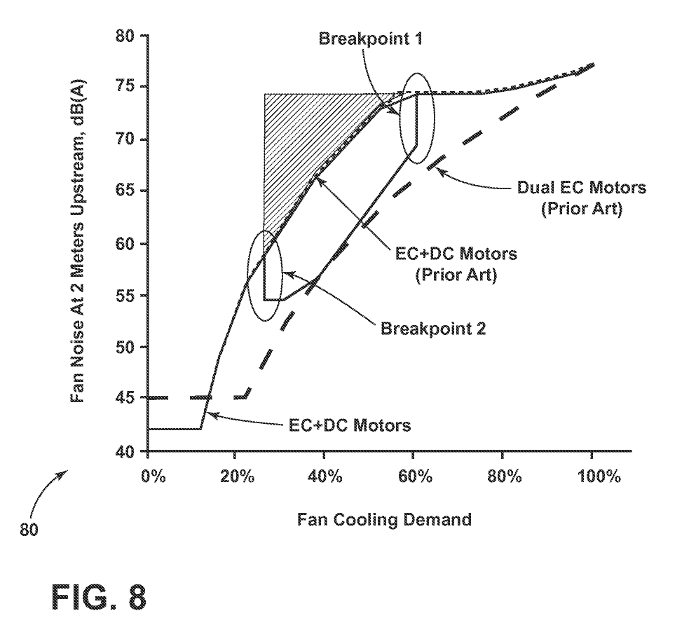

FIG. 7 and FIG. 8 show a comparison of the arrangement of FIG. 3 with two prior art arrangements. As set forth above, FIG. 7 shows a graph 80 for electric power versus a desired fan cooling demand for the corresponding motors 14, 18. FIG. 8 shows a graph 90 of noise output by the pair of cooling fans 12, 16 at various fan cooling demand percentages. The noise is measured at a distance of two meters upstream or forwardly from the mounting location of the cooling fans 12, 16 on a vehicle or in a vehicle engine compartment.

In FIGS. 7 and 8, an equivalent of the arrangement disclosed and shown in prior art DE '236 is also plotted in comparison with an embodiment of the invention. In FIG. 7, the electric power versus fan cooling demand of DE '236 is represented by a short dash broken graph line. From 0% to breakpoint 2 and from breakpoint 1 to 100% of fan cooling demand, the short dash line corresponds to the solid line for the EC motor 14 and the DC motor 18 of the invention. Thus, the difference in operation is between breakpoint 1 and breakpoint 2, wherein the embodiment disclosed in the invention provides better fan cooling using less electric power. In FIG. 8, again the graph line of DE '236 is provided in short dash line and corresponds to the graph line of the EC motor and DC motor embodiment of the invention from 0% to breakpoint 2 and also from breakpoint 1 to 100% of cooling demand, whereat the EC motor 14 and the DC motor 18 operate at maximum speeds.

The shaded or cross hatched area in FIGS. 7 and 8 represents conditions where the DC motor of DE '236 must operate in the event that the vehicle is idling at rest and the EC motor 14 provides air flow 21 through the condenser 9, the radiator 10 and the EC cooling fan 12 into the engine compartment that is returned as shown by arrow representing the return of heated air flow 22 in the opposite direction. Thus, the DC motor 18 must be operated to prevent the return of heated air flow 22 through the DC cooling fan 16 to the radiator 10 and the condenser 9.

The shaded area in FIGS. 7 and 8 also may be required for the DE '236 system when the high speed operation of the DC motor is called for only during peak engine cooling demand (e.g. hot weather hill climb). Since DE'236 allows for only one speed of the DC motor, that motor must run at full speed with accompanying high power consumption and noise whenever the single EC driven fan is insufficient to maintain adequate cooling of the condenser. The present invention allows for operation of the engine cooling fan system 8 at lower power and noise as shown in FIGS. 6-8, when maximum power is not required for the DC motor 18. Accordingly, the present invention has a more desirable operating curve and operates in an efficient manner.

In FIGS. 7 and 8, the long dash broken line shown in the graphs 70, 80 corresponds to a fan cooling system having dual EC motors. As set forth above, the disclosed combination of dual EC motors provides power efficiency and reduced noise output, but at significantly greater cost. As set forth above and as shown in FIGS. 7 and 8, the disclosed arrangement provides similar performance to the dual EC motor arrangement at a significantly lower beneficial cost.

Motor vehicles are often fitted with a vehicle heating, ventilation and air conditioning system to maintain a comfortable temperature in the passenger compartment during hot or humid weather. As part of the vehicle air conditioning system, a condenser 9 is customarily installed in the engine compartment immediately in front of the radiator 10, so that the cooling fans 12, 16 will draw outside air through the condenser and radiator when the cooling fans are operating. The function of the condenser 9 is to cool and condense the vehicle A/C refrigerant, which has been vaporized in the process of removing heat from the passenger compartment.

The function of the condenser 9 requires that it is provided with cooling air flow at all times that the vehicle air conditioning system is operating. When a vehicle is standing at idle, this airflow must be provided by the cooling fans 12, 16. In the case when both cooling fans 12, 16 are operating, the condenser 9 is more or less uniformly cooled by the operation of the two cooling fans 12, 16 providing air flow across the entire surface of the condenser 9. This air flow 21, after having passed through the condenser 9, the radiator 10, and cooling fans 12, 16, flows into the engine compartment and around the engine 11 and other under hood components, before eventually leaving the engine compartment as shown in FIG. 1. The air flow 21 leaves the cooling fans 12, 16 at a substantially higher temperature than the outside air, having been heated by passing through the radiator 10 and the condenser 9 and around the hot surfaces of the engine 11.

In the case that only one of the two cooling fans 12, 16 is operating when the vehicle is stopped with the engine idling, the heated air in the engine compartment will have a tendency to backflow or return air flow 22 in an essentially reverse direction from the engine compartment through the radiator 10 and the condenser 9 in reverse direction with respect to the direction of the air flow 21 due to the blockage of the air flow by the engine 11 and lack of operation of the DC motor 18 of the DC cooling fan 16, as shown in FIG. 2. In this situation, the function of the vehicle air conditioning system will be severely degraded, for two reasons: first, only half of the condenser 9 is receiving outside air for cooling; and second, the area of the condenser 9 that is subjected to the reverse flow of hot air from the engine compartment will tend to re-heat the A/C refrigerant in the condenser of the vehicle air conditioning system instead of cooling.

Normally a low operating speed of the DC motor 18 of the DC cooling fan 16 is sufficient to prevent the reverse air flow at idle and provide sufficient cooling of the condenser 9 at all operating conditions. In DE '236, there is no breakpoint 2 at a lower temperature or condition to power the DC motor. Thus, as shown in FIGS. 7 and 8, the DC motor of DE '236 does not actuate on until breakpoint 1.

The breakpoints 1 and 2 of the invention can be set to occur at higher or lower values of the fan cooling demand in order to modify the size of the fan power, fan airflow, and/or fan noise at each breakpoint. Further, the breakpoints can be set to occur at different fan cooling demand values depending on whether the fan cooling demand is increasing or decreasing at the time the breakpoint is encountered. At start-up, the DC cooling fan 16 is in an off condition until the EC fan speed increases to a breakpoint after start-up or breakpoint 2. Another breakpoint or breakpoint 1 occurs at a high fan cooling demand beyond the breakpoint after start-up.

Any of the control signals can originate from a source other than the ECU 30. For example, the fixed predetermined speed levels of the DC motor 18 are activated by a temperature switch 58 or pressure switch 56 as shown in FIG. 4, which are integrated into the engine cooling and/or vehicle air conditioning system. Other devices separate from the ECU 30 can be used to produce any or all of the control signals V1, K1, K2. Further, the DC motor can be activated by one or more temperature switches or one or more pressure switches. For instance, one or more temperature switches of a group of temperature switches may activate the DC motor 18 at a particular operating speed. In another embodiment, the pressure switch 56 shown in FIG. 4 is replaced with a temperature switch to activate the DC motor 18 at another operating speed.

EC motor speed is reduced as the fan speed demand is reduced, until the EC motor 14 is operating at its minimum speed. When the vehicle cooling demand falls below a preset level, both the EC cooling fan 12 and the DC cooling fan 16 are powered off.

Further, a method of cooling a heat exchanger using a cooling fan system includes measuring conditions of one or more of an engine cooling system and a vehicle air conditioning system. The conditions include temperature, pressure and other desired properties. In some embodiments, the conditions assist in determining a desired change in cooling for the heat exchanger to control the individual fan speeds. In one embodiment, the cooling fan system provides cooling for a powertrain cooling system. In another embodiment, an electric vehicle includes a powertrain cooling system and does not include an engine cooling system.

Thus, the invention provides, among other things, a method and system for operating an EC cooling fan 12 essentially continuously and operating a DC cooling fan 16 at selected multiple speeds to provide efficient and inexpensive cooling for a condenser 9, a radiator 10 and an engine 11. Various features and advantages of the invention are set forth in the following claims.

What is claimed is:

1. A cooling fan system for a vehicle comprising:
an EC cooling fan including an electrically commutated (EC) motor with an essentially continuously variable speed over a defined range;
a DC cooling fan including a direct current (DC) motor having a first predetermined operating speed and a second predetermined operating speed that is less than the first predetermined operating speed; and
a fan control circuit for controlling the variable speed of the EC motor in response to an EC motor speed signal, and for controlling the DC motor at the first predetermined operating speed in response to a first DC motor speed signal and at the second predetermined operating speed in response to a second DC motor speed signal.

2. The cooling fan system according to claim 1, wherein the cooling fan system comprises an engine cooling dual fan system.

3. The cooling fan system according to claim 1, wherein the fan control circuit includes a resistor in series with the DC motor for operating the DC motor at the second predetermined operating speed.

4. The cooling fan system according to claim 1, wherein operation of the DC motor at the second predetermined operating speed is achieved by means of multiple armature windings for the DC motor, a disconnecting circuit for disconnecting one or more brushes of the DC motor, or a connecting circuit for connecting additional brushes for operating the DC motor at the first predetermined operating speed and at the second predetermined operating speed.

5. The cooling fan system according to claim 1, wherein one of the DC motor speed signals is directly provided by one or more temperature switches integrated into one or more of an engine cooling system and a vehicle air conditioning system.

6. The cooling fan system according to claim 1, wherein the first DC motor speed signal is directly provided by a temperature switch integrated into one from a group consisting of an engine cooling system, a powertrain cooling system and a vehicle air conditioning system, and the second DC motor speed signal is directly provided by a pressure switch integrated into one of a group consisting of: the engine cooling system, the powertrain cooling system and the vehicle air conditioning system.

7. The cooling fan system according to claim 1, including an engine control unit, and wherein the EC motor speed signal and the first and second DC motor speed signals are output from the engine control unit.

8. The cooling fan system according to claim 7, wherein the engine control unit includes an EC output port connected to the electronic fan control circuit to provide the EC motor speed signal,
wherein the engine control unit includes a separate first DC output port and a second DC output port connected to the electronic fan control circuit to provide the first DC motor speed signal and the second DC motor speed signal, and
wherein when no first DC motor speed signal and no second DC motor speed signal is provided by the engine control unit, the DC motor is in an off condition.

9. The cooling fan system according to claim 8, wherein the EC cooling fan and the DC cooling fan operate in one of
a first state wherein the EC cooling fan is operating at an essentially continuously variable speed and the DC cooling fan is not operating,
a second state wherein the EC cooling fan is operating at an essentially continuously variable speed and the DC cooling fan is operating at the second predetermined operating speed, and
a third state wherein the EC cooling fan is operating at an essentially continuously variable speed and the DC cooling fan is operating at the first predetermined operating speed.

10. The cooling fan system according to claim 1, including
an engine coolant temperature sensor for providing an engine coolant temperature,
an engine control unit having a processor configured to:
receive the engine coolant temperature,
determine a desired change in cooling for engine coolant to obtain an adjustment for a fan cooling demand to obtain a desired coolant temperature, and
generate the EC motor speed signal and one from a group consisting of the first DC motor speed signal, the second DC motor speed signal, and no DC motor speed signal depending on the adjustment for the fan cooling demand,
the electronic fan control circuit further comprising:
a first relay configured to receive the first DC motor speed signal,
a second relay configured to receive the second DC motor speed signal, and
a resistor in series with the DC motor,
wherein the first relay provides power to the DC motor to operate the DC cooling fan via the DC motor at the first predetermined operating speed in response to the first DC motor speed signal, and the second relay provides power to the DC motor via the resistor to operate the DC cooling fan via the DC motor at the second predetermined operating speed in response to the second DC motor speed signal.

11. Method of cooling a cooling system of a vehicle using a cooling fan system comprising:
measuring conditions of the cooling system;
determining a desired change in cooling for the cooling system;
based on the desired change in cooling, controlling individual fan speeds by
controlling an electrically commutated (EC) motor for continuously variable speed of an EC cooling fan; and
selectively controlling a direct current (DC) motor of a DC cooling fan to perform one of:
provide no power to operate the DC cooling fan,
operate the DC cooling fan at a first predetermined operating speed corresponding to a first DC motor speed signal and
operate the DC cooling fan at a second predetermined operating speed corresponding to a second DC motor speed signal that is less than the first predetermined operating speed.

12. The method according to claim 11, the measuring of the conditions of the cooling system including:
measuring a temperature of at least one from a group consisting of an engine coolant and a refrigerant of a vehicle air conditioning system; and
measuring a pressure of at least a refrigerant of a vehicle air conditioning system.

13. The method according to claim 11, wherein controlling the desired change in cooling includes:
at a first breakpoint after start-up of the cooling fan system, essentially simultaneously
changing the DC motor from receiving no signal and not operating the DC cooling fan to providing the DC motor with the second DC motor speed signal to operate the DC cooling fan at the second predetermined operating speed, and
decreasing the variable speed of the EC cooling fan to essentially offset the increase in speed of the DC cooling fan.

14. The method according to claim 13 wherein controlling the desired change in cooling includes:
at a second breakpoint, the desired change in cooling provided by the EC cooling fan and the DC cooling fan is increasing after increasing beyond the first breakpoint after start-up of the cooling fan system, by essentially simultaneously
changing the DC motor from providing the DC motor with the second DC motor speed signal to operate the DC cooling fan at the second predetermined operating speed to providing the DC motor with the first DC motor speed signal to operate the DC cooling fan at the first predetermined operating speed, and
decreasing the variable speed of the EC cooling fan to essentially offset the increase to the first predetermined operating speed of the DC cooling fan.

15. The method according to claim 11, wherein the cooling system includes a radiator for receiving an engine coolant.

16. The method according to claim 11, wherein the cooling system includes a condenser for receiving a refrigerant from a vehicle air conditioning system.
